(19) United States
(12) Patent Application Publication
(10) Pub. No.: US 2021/0112824 A1
(43) Pub. Date: Apr. 22, 2021

(54) PROCESS OF CHOCOLATE PRODUCTION

(71) Applicant: Jean-Philippe LECLERC, Quebec (CA)

(72) Inventor: Jean-Philippe LECLERC, Quebec (CA)

(21) Appl. No.: 17/071,237

(22) Filed: Oct. 15, 2020

Related U.S. Application Data
(60) Provisional application No. 62/915,876, filed on Oct. 16, 2019.

(51) Int. Cl. A23G 1/36; A23G 1/48; A23G 1/12; A23G 1/00

(52) U.S. Cl. CPC A23G 1/36; A23G 1/48; A23G 1/0013; A23G 1/004; A23G 1/125

(57) ABSTRACT

The process can include mixing ingredients into a cocoa mass, conching the cocoa mass, and, subsequently to conching, measuring viscosity of the conched cocoa mass, contingent upon said viscosity being higher than a target viscosity value, calculating, based on the measured viscosity and reference data representing a reference model of viscosity vs. viscosity-reducing substance content for the chocolate to be produced, a quantity of cocoa butter to be added to the cocoa mass, and adding the quantity of cocoa butter to be added to the cocoa mass.

### BACKGROUND

Chocolate is an increasingly popular commodity, and the production in the Americas and in Europe alone has been estimated to over 5 million tons in 2016. Most industrial chocolate production processes involve a sequence of steps including mixing, grinding, conching, and typically tempering and moulding or otherwise shaping, but some chocolate products are sold or transported in liquid form. While various types of chocolates exist and specific recipes depend on the chocolate type, conching is known to significantly affect the quality of chocolate and allows to improve the taste and fineness of the finished product. Conching involves creating sustained mechanical stresses and heat in the cocoa mass, which contributes to deagglomerate the cocoa mass and remove undesirable aromas. Higher quality products typically involve longer conching times than lesser quality products. At the end of conching, emulsifiers can be added, depending on the recipe. Even though existing chocolate production processes were satisfactory to a certain degree, there always remains room for improvement. In particular, there always remains a motivation to reduce costs while continuing to meet or exceed specifications.

### SUMMARY

It is relatively common for chocolate production specifications to include a maximum viscosity specification for the chocolate. The maximum viscosity specification can depend on the purpose of the chocolate, because, for example, chocolates which are intended to be used for chocolate coatings can require a relatively low viscosity to correctly perform the coating function. However, even where there are no specific external demands on viscosity, such as in the case of chocolate chip production for instance, the chocolate mass still typically needs to be processable by the available equipment, which can become difficult above a certain level of viscosity, and the level of viscosity above which processing is deemed to become difficult can be set as the maximum viscosity specification, for instance.

The percentage of fat in the recipe affects the viscosity of the chocolate mass, and the percentage of fat is dependent on the total quantity of fat contained in the raw ingredients which are initially added together and mixed. Other substances than fatty substances can also have an effect on viscosity, such as emulsifiers (e.g. lecithin, PGPR), for instance. For clarity in the following disclosure, all such ingredients, or mix of such ingredients, the content of which has an effect on the viscosity, will be referred to herein as “a viscosity-reducing substance”. Moreover, conching in particular, and some other process variables, can also affect viscosity of the chocolate mass. For this reason, it can be desired to put a bit more fat-containing substance (e.g. one or more fat-containing ingredients such as cocoa butter, cocoa liquor, butter oil, or even milk powder), an emulsifier, and/or other viscosity-reducing substance, at the step of mixing to ensure that the maximum viscosity specification will be met later into the process. However, using this approach, and due to the process variations, the final viscosity sometimes ends up being significantly lower than the maximum threshold value, by a quantity which could fluctuate at the batch level. Henceforth, even though this method can allow to consistently meet the target, it can recurrently lead to exceeding the minimum required quantity of viscosity-reducing substance. Cocoa butter, an example typical viscosity-reducing substance, is a relatively expensive ingredient in chocolate production, and the quantity of cocoa butter contained in the cocoa mass corresponding to the extent to which the viscosity specification was exceeded (by reaching a lower viscosity than required) may represent a waste of a valuable resource. It will be understood that a viscosity-reducing substance can also include ingredients which do not reduce viscosity, as long as it contains some degree of viscosity-reducing content.

To avoid exceeding the viscosity specification (i.e. wasting viscosity-reducing substance), it can, on the contrary, be preferred to limit the quantity of viscosity-reducing substance included in the initial ingredients, while keeping the possibility open of adding a quantity of viscosity-reducing substance near the final steps of the process, such as during the step of conching. For example, one may conch until the chocolate mass has stabilized, measure the viscosity, and, if the viscosity threshold has not been met, add a quantity of fatty substance and perform an additional step of conching. This latter approach can avoid or reduce the quantity of fat-containing substance used, while still meeting the minimum viscosity threshold, at the cost of additional conching time.

In accordance with one aspect, there is provided a method of producing chocolate comprising mixing ingredients into a cocoa mass, refining the cocoa mass, and conching the cocoa mass, and, subsequently to conching, measuring viscosity of the conched cocoa mass, contingent upon said viscosity being higher than a target viscosity value, calculating, based on the measured viscosity and reference data representing a reference model of viscosity vs. viscosity-reducing substance content for the chocolate to be produced, a quantity of viscosity-reducing substance to be added to the cocoa mass, and adding the quantity of viscosity-reducing substance to be added to the cocoa mass.

In accordance with another aspect, there is provided a chocolate production line wherein a computer determines a quantity of viscosity-reducing substance to be added to the cocoa mass between conching and shaping based on measured viscosity and reference data representing a reference model of viscosity vs. viscosity-reducing substance content. Viscosity can be measured by pumping the cocoa mass from and to the conche, along a recirculation loop where a viscometer is present, for instance.

During the additional conching time, the equipment is not free to accommodate the next batch, and the next batch can thus be considered to have been delayed. The same question can be raised when selecting the quantity of viscosity-reducing substance to be added after the first conching phase, or after a subsequent conching phase: if the quantity is lower than required, yet another viscosity-reducing substance addition and a further conching phase will be required before meeting the minimum viscosity threshold, also leading to additional production time and further delaying the next batch. Such longer production time can be equated to additional costs as well, and the operator must then choose between sparing the viscosity-reducing substance, speeding the production time, and finding some balance in between, given the specificities of the exact implementation.

Henceforth, in accordance with one aspect, there is provided a method of adding a quantity of viscosity-reducing substance subsequently to a given conching phase, the method including measuring the viscosity of the chocolate mass after the given conching phase, determining a quantity of viscosity-reducing substance to be added, adding the determined quantity of viscosity-reducing substance, and performing a subsequent conching phase, wherein said determining the quantity of viscosity-reducing substance includes determining a difference between the measured viscosity and a target viscosity value, associating the difference to a basic quantity of viscosity-reducing substance to be added based on a reference model, the associated quantity having a margin of error, and selecting, for the quantity of viscosity-reducing substance to be added, a value different from the basic value, but within the margin of error.

Independently of the operator's preference for a given implementation (i.e. whether it is preferred to spare viscosity-reducing substance, speed production time, or achieve a balance between the two former considerations), it can be preferred to obtain an estimation, or prediction, of the fat content required to meet the viscosity threshold which is as precise as possible, as this will allow to reduce or avoid either one, or both, of the undesired i) excess quantity of viscosity-reducing substance and ii) additional production time. The subject of improving the prediction accuracy is somewhat vast, and will be explored in further detail below, as various methods can produce reference models linking a quantity of fat content to a viscosity or to a change in viscosity. Such a reference model will typically have some margin of error. However, in some cases, the margin of error can be known in the absolute, or with a certain degree of confidence. The reference model can be specific to a given recipe, or more general, such as using a same reference model for different recipes of a given type of chocolate, for instance. As presented above, one will likely be motivated to use a reference model which will be the most likely to be accurate in light of the circumstances, and therefore for which the margin of error is the smallest, if more than one reference model is available.

It was found that many reference models had margins of error which could be improved/reduced based on actual measured values stemming from previous iterations of the same recipe on the same equipment. Accordingly, in accordance with another aspect, there is provided a process of producing a plurality of batches of a given recipe of chocolate, wherein for each batch, an initial quantity of viscosity-reducing substance and/or a subsequently added quantity of viscosity-reducing substance is determined based on a reference model associated to the recipe, and wherein the reference model is modified or updated between an earlier batch and a later batch based on one or more viscosity measurements taken during the preparation of the earlier batch.

In accordance with another embodiment, there is provided a method of producing chocolate comprising: producing a first batch of chocolate including mixing an initial recipe of ingredients into a cocoa mass, conching the cocoa mass, and, subsequently to at least one phase of said conching, measuring viscosity of the conched cocoa mass, contingent upon said measured viscosity value being lower than a target viscosity value, reducing a quantity of viscosity-reducing substance specified in the initial recipe of ingredients, and producing a second batch of chocolate including mixing the initial recipe of ingredients having a reduced quantity of viscosity-reducing substance into a cocoa mass and conching the cocoa mass.

It will be understood that the expression “computer”, a generic example of which is presented in FIG. 8, as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), programmable logic controller (PLC) to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keybord, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Bluetooth, WMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. The processor, controller, memory, can all be local, or one or more of these can be in part or in whole remote, distributed or virtual.

Many further features and combinations thereof concerning the present improvements will appear to those skilled in the art following a reading of the instant disclosure.

### DESCRIPTION OF THE FIGURES

In the figures,

FIG. 1 is a schematic view of a chocolate production line;

FIG. 2 is a graph illustrating a reference model specifying a margin of error;

FIG. 3A is a graph illustrating a first example scheme of calculating an amount of viscosity-reducing substance to be added;

FIG. 3B is a graph illustrating a second example scheme of calculating an amount of viscosity-reducing substance to be added;

FIG. 4 is a flow chart showing a process of correcting viscosity between conching and shaping;

FIG. 5 is a graph illustrating how a quantity of cocoa butter to be added can be calculated using reference data;

FIG. 6 is a flow chart showing a process similar to FIG. 4, but wherein either one, or both, of the quantity of fat-containing ingredient to be added and the reference data itself can be adjusted based on the presence of a difference between the measured viscosity and known fat content, and the corresponding reference values in the reference data;

FIG. 7 shows three examples of curve fitting based on three points of actual batch data; and

FIG. 8 is a schematic view of a generic computer.

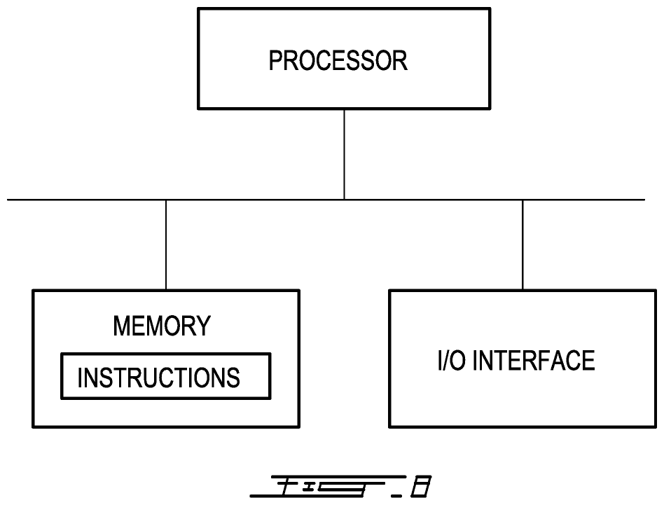

### DETAILED DESCRIPTION

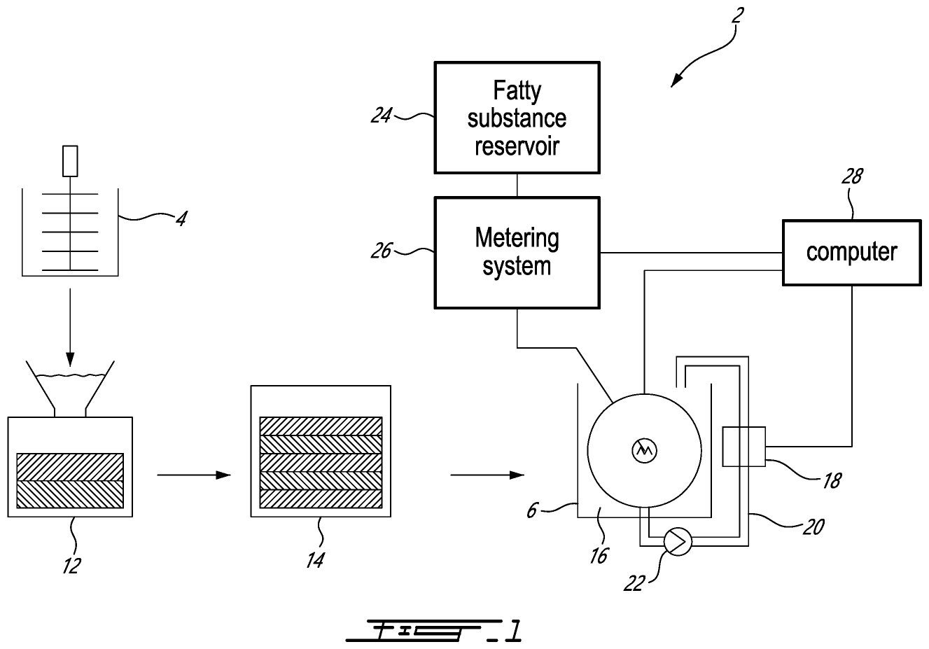

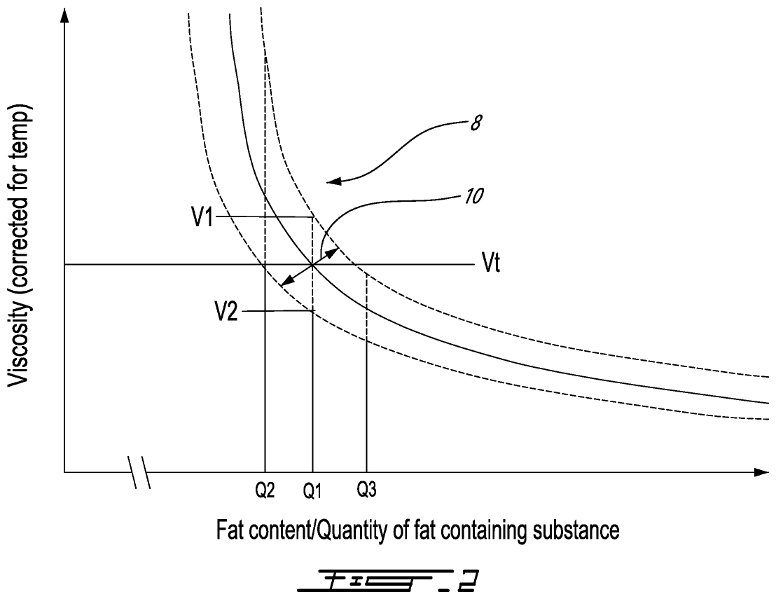

FIG. 1 shows an example of a chocolate production line 2. In this production line, a mixer 4 is provided which receives the initial ingredients of a specific chocolate recipe, such ingredients can include specific quantities of chocolate liquor, cocoa butter, milk powders and/or sugar for instance, as known in the art. Due to inherent variability in the later steps of the process, and in the step of conching 6 in particular, there is an inherent variability in the fat content which will lead to a specific viscosity value (typically provided in the form of a minimum viscosity threshold). The relationship between viscosity and fat content is typically at least roughly of the inversely proportional type, such as schematized as FIG. 2, and an established relationship for a given recipe can be referred to as a reference model 8. For instance, as shown in FIG. 2, the reference model 8 can associate a basic fat content Q1 to the target viscosity Vt, but that basic fat content Q1 may be known to typically lead to a certain variability of viscosity values, say typically between V1 and V2, due to the margin of error 10. If the end result is V1, the target viscosity Vt will not have been met with the first conching phase. If the end result is V2, the target viscosity Vt will have been exceeded and therefore fat containing substance will have been wasted. In light of this process variability, the fat content (i.e. the amount of fat containing substance) in the ingredients initially added to the mixer 4 can intentionally be selected to be lower, or higher, than the basic fat content Q1. Indeed, one may prefer to select a minimal quantity Q2, which will be sure to avoid wasting fat containing substance; a maximal quantity Q3, which will be sure to avoid a subsequent conching phase, or some balance between these two extreme considerations.

Returning to FIG. 1, after mixing the initially provided ingredients in the mixer 4, the mixer 4 feeds a prefiner 12 where a level of grinding is performed, and from there, the chocolate mass is fed to a finer 14, where a finer level of grinding is performed. The chocolate mass is then fed from the finer 14 to the conche 16, where the step of conching 6 is performed. As will be discussed below, in this example, a viscometer 18 is placed in a recirculation loop 20 associated to the conche 16 and having a pump 22, and can be used to measure the viscosity of the cocoa mass once one or more phase(s) of the conching step 6 is done. The viscosity can then be adjusted by adding a quantity of viscosity-reducing substance in the conche 16. The addition of viscosity-reducing substance provided to the conche 16 from a viscosity-reducing substance reservoir 24 can be dosed with a metering system 26, for instance. The quantity of fat content to be added can be calculated using a computer 28, based on the measured viscosity value, the target viscosity value, on the quantity of fat content already present in the cocoa mass, and on a reference model, and be translated by the computer 28 into a quantity of fat content/quantity of fat containing substance to be added.

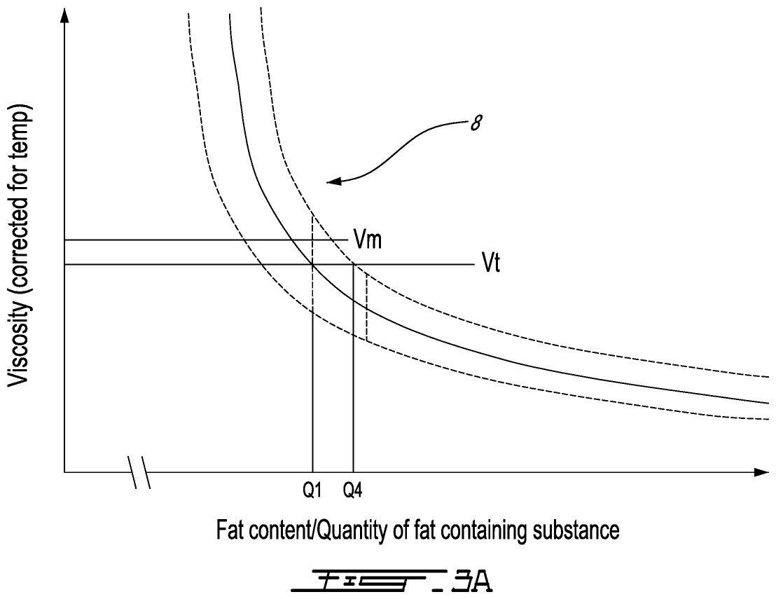

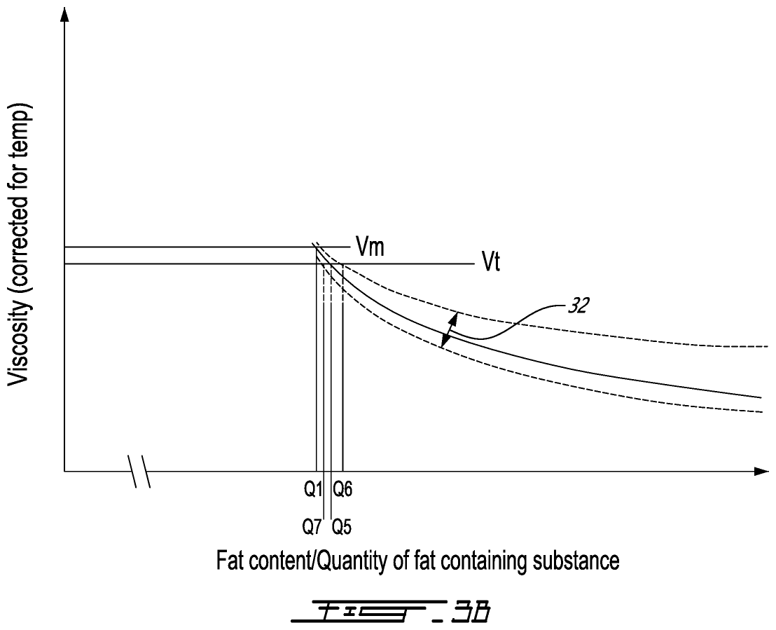

This latter sequence of steps is perhaps best illustrated in FIGS. 3A and 3B, which both show an example scenario where a initial fat content Q1 is known to have initially been included in the initial ingredients mixed and directed through the first conching phase, and where the viscosity has been measured subsequently to the first conching phase, and determined to correspond to the measured viscosity Vm. The process can be automated, in a manner that a computer 28 (FIG. 1) can automatically perform a comparison between the measured viscosity Vm and the target viscosity Vt specification. Upon determining that the target viscosity Vt specification has not been reached, the computer 28 can conclude, and indicate that fat content addition is required. The question becomes: how much fat content addition is required. Again, a reference model can be used to link a quantity of fat containing substance addition to a value of reduction in viscosity. Here again, due to inherent variability in the conching process, a margin of error may exist. The margin of error may be significantly lesser than the initial margin of error (e.g. margin of error 10 in FIG. 2), but be significant nonetheless.

FIG. 3A represents perhaps a relatively simple scheme. After the first conching phase based on a known quantity of fat Q1, the viscosity measurement Vm yields that the viscosity is still above the target viscosity Vt (or viscosity threshold). In an “aggressive” scheme, a quantity of fat Q4 determined to ensure that the target viscosity Vt is met using the initial reference model 8 can be determined, and a quantity of viscosity-reducing substance corresponding to the difference between fat content Q4 and Q1 can be added. This may lead to wasting viscosity-reducing substance, but the amount of viscosity-reducing substance wasted will likely have been less than if a greater quantity Q1 had initially been introduced into the mixture based on a similar “aggressive” scheme.

In practice, the margin of error can, for instance, be somewhat proportional to the difference between the measured viscosity Vm and the target viscosity Vt. Accordingly, a new reference model having a lower margin of error may be established by updating the initial reference model with the additional information of the measured viscosity Vm, and focussing on the remaining unknowns, such a scheme is presented in FIG. 3B. Here, the updated reference model 30 may provide a basic fat content value Q5, the difference of which, with the current fat content value Q1, can be determined to correspond to a diminution of viscosity allowing to precisely meet the target viscosity value Vt. However, given the margin of error 32, the addition of the basic added fat content value (Q5 minus Q1) may lead to an actual, measured, viscosity value which can either be greater or lower than the target viscosity value Vt, subsequently to the second phase of conching. The margin of error 32 can extend, within a certain degree of confidence, between a maximum quantity Q6 and a minimum quantity Q7, to achieve a given target viscosity Vt. Here as well, an operator may prefer to focus on a minimal amount of added fat content, introducing an amount corresponding to value Q7-Q1 to achieve a total fat content lower than the basic fat content value Q5, and corresponding to a minimum fat content Q7, ensuring that no fat containing substance is wasted. Alternately, the operator may prefer to introduce a maximal amount of added fat content value of Q6-Q1 to make sure that the added fat content will allow to meet the target viscosity value Vt, and avoid an ulterior addition and associated conching phase. It will be understood that the operator may also prefer to balance the exact quantity added to a value different that Q5-Q1, but somewhere between Q7-Q1 and Q6-Q1, such as by adding a quantity of fat content higher than the minimum value by a specified amount, contingent upon said added quantity avoiding to go through another conching phase. Whatever the preference in view of a specific recipe, the associated instructions can be provided to the computer which can control the fat content addition, and perhaps also the remainder of the process, such as the next conching phase, and eventual next viscosity measurement, automatically.

A process essentially the same as the one shown in FIG. 3A or 3B can also be applied after a second conching phase, such as when the amount of added fat content between the preceding conching phase(s) has led to not yet reach the target viscosity Vt as per the corresponding viscosity measurement Vm, where yet another fat content addition is performed, followed by yet another conching phase, and potentially further viscosity measurement, fat content addition, etc. until the target viscosity is met.

As will be discussed in further detail below, various ways of forming a reference model can be used. Interestingly, in some embodiments, the reference model can be refined based on data points stemming from viscosity measurements taken from actual, preceding batches, for the same recipe of chocolate. For example, if a given recipe leads to a initially measured viscosity (after first conching phase), which is always higher than the target viscosity by a significant amount, the recipe can be adjusted in a manner for the initial quantity of fat containing substance to be higher by a certain amount, and the reference model used to determine the amount of fat to be added as a function of a difference between measured viscosity and viscosity target can be adjusted. The same can be true even during the preparation of a given batch, where, for instance, if the difference between the measured viscosity and the viscosity target is determined to exceed a given amount, the reference model can be adjusted before calculating the quantity of fat containing substance to be added, and any quantity of fat containing substance to be added can be calculated based on a reference model which has been updated as a function of points measured either a) earlier in the preparation of the same batch, b) in the preparation of earlier batches or c) both. To a certain extent, using somewhat advanced techniques, adjustments to a given reference model associated to a given recipe, can be made based on measurements taken during the preparation of one or more other recipes. Indeed, such a technique can be used, for example, if a given conche is identified as always producing a viscosity bias which other conches do not produce, the reference model used in that given conche can be adjusted accordingly.

In one embodiment, for instance, if a given recipe leads to exceeding the viscosity specification after a first phase of conching of an earlier batch, the initial quantity of viscosity-reducing substance specified that recipe can be reduced, and the so-reduced quantity of viscosity-reducing substance can be used instead of the earlier quantity of viscosity-reducing substance in a subsequent batch.

Let us now turn to the question of building a reference model, in a context where the expression “reference model” can also include the definition of the initial ingredient mix. Temperature affects viscosity of chocolate, but does so in a highly predictable manner via equations which are available in literature. To avoid scenarios where different viscosity readings are taken at different temperatures and therefore biased by the temperature variable, all viscosity readings can be normalized to a reference temperature, and viscometers are available on the market which can perform this automatically. Accordingly, it will be assumed in the following text that when compared to one another, such when building a reference curve or when comparing a viscosity reading to a reference curve, viscosity readings are either taken at the same temperature, or have been corrected to factor out the effect of temperature on the individual readings, essentially allowing to “compare apples with apples”. Accordingly, no further reference to temperature correction will be made in this text, temperature correction, if required, being implicit to the values of viscosity referred to.

It was found that at the exit of the conching system 16, the viscosity was more reliably related to the percentage of fat content than at the entry of the mixer 4. Indeed, the percentage of fat content after conching is adjustable via liquid fat-containing ingredient addition, such as cocoa butter, cocoa liquor, butter oil for instance, and can thus be changed to cause a corresponding change in viscosity. That is, the typical statistical deviation in the estimation of the quantity of fat content required to reach a target viscosity was significantly lower when performed after conching than in an initial determination of the respective quantities of ingredients to be introduced prior to mixing. Indeed, since no more significant physical changes are done to the cocoa mass after conching, it can be practical to take the viscosity reading at that point, at which stage fat content can be the only significant variable affecting viscosity. This can make it interesting to select the reference model, or to adjust the reference model, based on the actual measured viscosity after a first (or more than one) conching phase.

Accordingly, in accordance with one aspect, there is provided a chocolate production process, wherein the quantity of fat included in the ingredients added at the mixing step 4 is voluntarily reduced relative to the basic quantity of fat expected to be required to reach the target viscosity value. It can be reduced to a minimum value of the margin of error, for instance. The viscosity is measured after the conching step 6, the difference between the measured viscosity and a target viscosity value is determined, reference data in the form of a reference curve or table can be used to calculate a quantity of liquid fat-containing ingredient(s) to be added for the viscosity to meet the target viscosity value, and a quantity of liquid fat-containing ingredient(s) can then be added to the chocolate mass based on the calculation, after conching.

Indeed, viscosity can be related to fat content at least roughly by a negative exponential equation, which can correspond to a curve such as illustrated in FIG. 2. In one example, the reference model can be based on an equation in the in the form of: Corrected Viscosity (at corrected temp)=A*e\hat{ }(−B*Fat content+C)+D, where A, B, C and D are variables which depend on the specific recipe, and as such, a reference model for a specific recipe can use corresponding values of the variables A, B, C and D in the context of this equation, where the fat content can be known as per the quantity of fat contained in the raw ingredients added in the mixer, and later taking into consideration the quantity of liquid fat-containing ingredient addition subsequent to conching, and viscosity can be measured at the conche 16, after conching. The margin of error can be established independently, for instance, and can be selected as a specified percentage of the value of fat content to be added following the first conching phase, for instance. Alternately, the margin of error can be established on the basis of actual data collected from one or more earlier batches of the same recipe prepared by the same, or by similar equipment, for instance. In some alternate methods of producing a suitable reference model, a suitable algorithm, or neural network, can be used to build a reference model which automatically suggests a single proposed value of fat content to be added based on measurements obtained from earlier batches and on certain specified parameters, such as “avoid wasting fat content” or “avoid a third conching phase” or “avoid an additional conching phase when the cost of ensuring to avoid an additional conching phase is below quantity X of additional fat content”. In still other embodiments, the margin of error and/or the basic values of the reference model can be determined by using statistical analysis techniques, curve fitting, regression, classification, clustering, dimension reduction, deep learning, neural networks, transfer learning, and/or reinforcement learning techniques, to name some examples. Various ways of implementing the evaluation of the margin of error may be used, and such a method can involve taking into consideration how much of the measured value or values of viscosity depart from the reference model. The more a measured value departs from the reference model, the more likely it is for the quantity of required fat-containing ingredient addition determined based on this model to be off the target by a certain extent, and accordingly, the greater the margin of error can be established. The determined margin of error can be used in various ways. In some embodiments, the statistical distribution of the margin of error can be weighed into the determination of the quantity of fat content to be added, this can particularly be the case when a value other than the minimum or maximum values of additional fat content indicated by the reference model are to be added. For instance, it can be desired to limit the quantity of fat content to be added to the extent where such limitation is deemed sufficiently unlikely to lead to a subsequently measured viscosity value which does not meet the target (e.g. below 5% probability based on model—in which case a subsequent conching phase would only be required once in each 20 batches on average, which may be deemed a suitable tradeoff given the expected diminution in the quantity of viscosity-reducing substance used over 20 batches using the technique).

In one example, one can wish to add a quantity of fat-containing ingredient corresponding to the sum of the basic estimated value and of the determined positive branch of the margin of error, to ensure that the fat-containing ingredient addition will result in reaching the target viscosity on the first try. Such an approach can be motivated by the fact that iterations in adding fat-containing ingredient to the cocoa mass in the conche take time, and therefore affects the capacity of the production line to move on to another batch. However, if in this specific case, the estimated value less the determined error would have been sufficient to reach the target viscosity value, one will have wasted a quantity of fat-containing ingredient corresponding to 2 times the determined error.

Alternately, it can be preferred, in some embodiments, to proceed in an iterative way by adding the basic estimated value less the negative branch of the determined margin of error, and once that is done, re-measure the viscosity, compare it to the target value, and if it has not yet reached the target value, determine the quantity of fat-containing ingredient to be added to reach it. This can allow to ensure that the quantity of fat-containing ingredient required to meet the viscosity target is not exceeded (overshot) and that no fat-containing ingredient is wasted.

In any event, as more viscosity values are obtained from measurement taken on batches, such experimental data can be used to finely adjust the reference model. In one specific example, a curve-fitting technique can be used to adjust the initial reference model curve to best fit the new actual viscosity measurement(s). This can be done taking into consideration that the relationship between viscosity (as corrected for temperature) and fat content will have a negatively exponential relationship such as: Corrected Viscosity (at standard temp)=A*e\hat{ }(−B*Fat content+C)+D, where A, B, C and D are the variables of the model which need to be adjusted to perform the best fit, which can be automated by a computer using commonly available software. Partial adjustments can be made even on the basis of a single measured viscosity and known fat content point, but fuller adjustments can be made when two or more points are ascertained. For instance, the solution for A, B, C and/or D which best fit the measured viscosity values at the two viscosity/fat content values (the initial fat content is known, and a known quantity of fat was added, which allows to know the second value of fat content) can be retained, and the quantity of viscosity-reducing substance to be added can be calculated on the equation using the refined values of A, B, C and D obtained via the curve fitting. The deviation of the measured points from the updated model can also be used to determine the likely degree of error in the calculated quantity of viscosity-reducing substance to be added, and if desired, this degree of error can be subtracted from the determined quantity of fat to yield the actual quantity of viscosity-reducing substance to be added to avoid over-compensation, and if desired, further iterations can be performed, with further measured points used to further refine the model if convenient, until the actual viscosity measured corresponds to the target value within acceptable tolerances.

The same production line can be used to produce different recipes of chocolate, each having their own reference model, and accordingly, the same line may be used to produce chocolate according to several other recipes before having to produce the same recipe of chocolate another time. However, when the same recipe comes back, the “learning” of the algorithm which took place the first time the process was performed can be harnessed to reduce the quantity of error, or the quantity of iterations, required to reach the target viscosity value in the subsequent batch. Indeed, the initial quantity of fat-containing ingredient added into the mixer can be determined using the refined model, i.e. the model previously corrected based on the actual fat content vs. viscosity behavior as measured, and/or the first quantity of added fat-containing ingredient in the subsequent batch can be calculated using the refined model.

It can be preferred to limit the ease at which the model can be modified based on actual measurements. Indeed, some measured effects of fat content vs. viscosity behavior can be specific to a given batch, or even be glitches, and in such scenarios, entirely basing the calculations of the quantity of fat-containing ingredient to be added to reach the target viscosity of the subsequent batch on the behavior of the previous batch can lead to a greater degree of error than if basing those calculations on a single, generic reference model representing the averaged behavior of a large number of batches. Similarly, it can even be preferred to limit the weight which is given to one or more measurements in the correction of the reference model used to correct that specific batch, and intermediately, or fully, modified reference models can be taken over to the next batch in a manner for the next batch to either have access to the reference model as last used in the previous batch, or to a reference model partially modified on the basis of the teachings received by the measurements taken in the previous batch. Accordingly, in some cases, it can be preferred to limit the effect that individual batches can have on the reference model which is taken to the next batch, which can be achieved by weighing in each measurement equally against all the previous measurements which took place, for instance, or in some cases, the corrections stemming from more recent measurements can receive greater weight than earlier measurements, in a manner to allow the reference model to adapt to progressive changes which can occur in the batches due to changes in the source product and/or in the environment. Ultimately, it may be desired to use artificial intelligence to determine how much weight is given to a given measurement either in determining the quantity of fat-containing ingredient to be added to the specific batch, or in correcting the reference model for future batches.

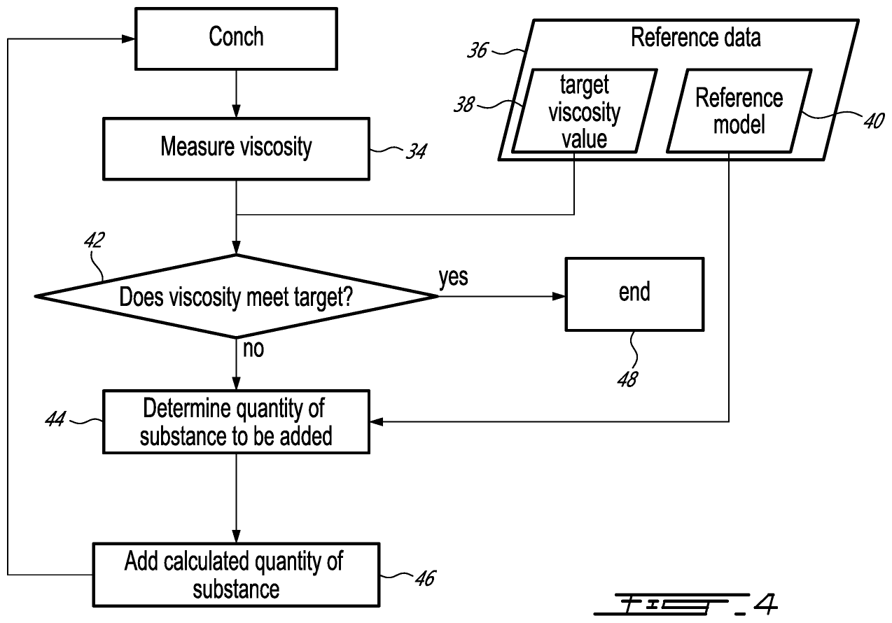

FIG. 4 shows an example flow chart illustrating the steps which can be performed using a computer. Indeed, the viscosity can be measured 34, or rather the equivalent of the viscosity for a given reference temperature can be determined, using a viscometer 18. The measured value of viscosity can be communicated to a computer 28, which can be done wiredly or wirelessly for instance. The computer 28 can have access to reference data 36 which can include both a target viscosity value 38 specification for the recipe, and a reference model 40 representing an expected relationship between fat content and viscosity for the recipe. The reference model 40 can factor in the initial amount of fat which was introduced into the mixer 4 or otherwise earlier in the process. In the reference model 40, the expected relationship can be presented in table form, but it may be more convenient with the computers available nowadays to present the relationship directly in the form of a mathematical equation. For instance, the reference data 36 can take the form of negative exponential mathematical equation of the following type:

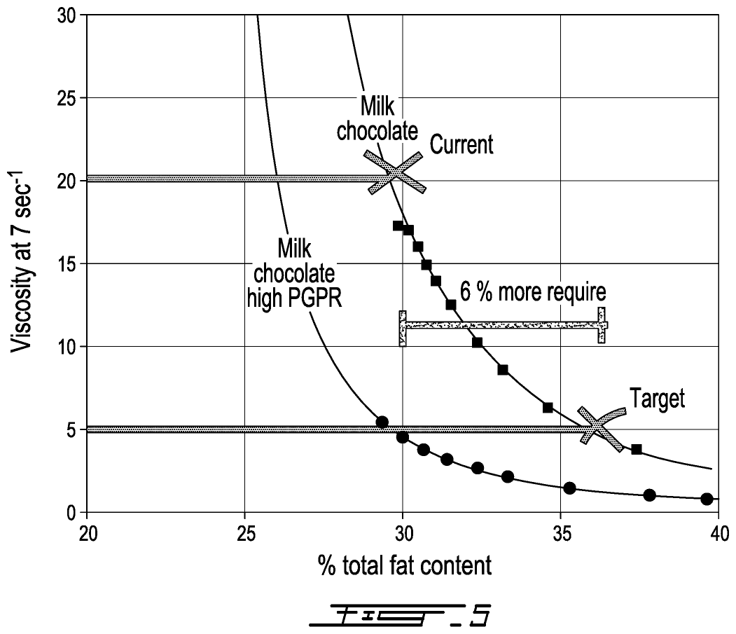

Corrected Viscosity(at standard temp)=A*e\hat{ }(−B*Fat content+C)+D (1)

where A, B, C and D are variables which depend on the specific recipe. Such a relationship, when presented in graph format, produce curves such as the example curves shown in FIG. 5. At the exit of the conche 16, this reference model 40 for viscosity behavior depending on fat content can be more reliable, and allow to achieve better precision, than the estimation of viscosity based on the quantity of fat content added at the time of mixing and at the early stage of the conching process.

The computer 28 can have access to reference data 36 including equations or tables, and associate initially introduced fat content (recipes) and viscosity targets for each of a plurality of recipes, and can select the correct reference data 36 based on a user input indicating the recipe corresponding to the current batch, for instance. For instance, milk chocolate and dark chocolate can have different recipes and reference data 36, and milk chocolate having different fineness, such as 25 μm, 35 μm and 50 μm, for instance, can have different recipes and reference data 36. Different computers can control different part of the process, and any processor, controller, memory etc, used, can either be local, or in part or in whole, remote and/or distributed and/or virtual.

The expression reference data 36 can also be used to encompass the target viscosity value 38 required for the specific recipe at the exit of the conche, for instance.

The reference data 36 for each recipe can be established by experimentally taking, for each recipe, and for a plurality of fat content values, a number of viscosity values at the exit of the conching, and this process can be repeated until satisfaction is achieved that the reference curves are satisfactorily representative of the given recipe's behavior. Indeed, with reference to FIG. 5, each time the viscosity is measured at a different fat content, a point can be added to the original reference point, and any other preceding reference point, and curve fitting can be used to adjust the model accordingly, potentially weighing in the amount of earlier reference points and the extent of deviation between any single reference point and the model.

Once the reference data for the specific recipe has been established, and by measuring viscosity 34 after the conching step 6, the computer 28 can determine, as exemplified in FIG. 5, how far we are from the desired viscosity along the curve, and the computer 28 can thus determine the quantity of fat which needs to be added 44 to reach the desired viscosity. The corresponding quantity of fat can then be added 46, in the form of specific quantities of one or more liquid fat-containing ingredients, to the cocoa mass to reach the desired viscosity. In many modern production lines, the addition of liquid fat-containing ingredients such as cocoa butter and cocoa liquor can be automated and can thus be driven directly by a computer 28 acting as a controller to a suitable metering system 26, based on the calculated value 44. The metering system 26 can be a pump associated to a flow meter and controlled by a computer 28 in a manner to deliver a specified quantity of viscosity-reducing substance based on the flow meter's reading, to name one example.

In theory, this will lead to the exact target viscosity which is desired for the specific recipe by using the minimum quantity of fat-containing ingredients, and can target a minimum quantity of cocoa butter in particular. In practice, when the viscosity is measured following stabilization after the addition, the exact value of viscosity will typically be at least slightly off the target value. The same process can be repeated at that stage to add further fat if the viscosity still needs to be added, but it can be desired to limit the quantity of cycles of fat addition on any single batch because additional cycles require more production time. However, on the other hand, if the viscosity is lower than the target, then fat-containing ingredients such as cocoa butter have been wasted. To avoid wasting cocoa butter, it can be desired to put a bit less cocoa butter than the quantity indicated by the curve, but this is tricky, because if too little cocoa butter is added, additional production time will be required for the subsequent iteration of adding cocoa butter.

It will be understood that the steps of determining 44 and adding a quantity of viscosity-reducing substance 46 need not be completed if the measured viscosity 34 meets the target viscosity value 38 within a certain range, which can be determined by the user. The computer 28 may verify if the viscosity meets the target viscosity 42 after each viscosity measurement 34, for instance, and instruct the production line that the product is ready to be tempered 48 should it meet the viscosity requirements.

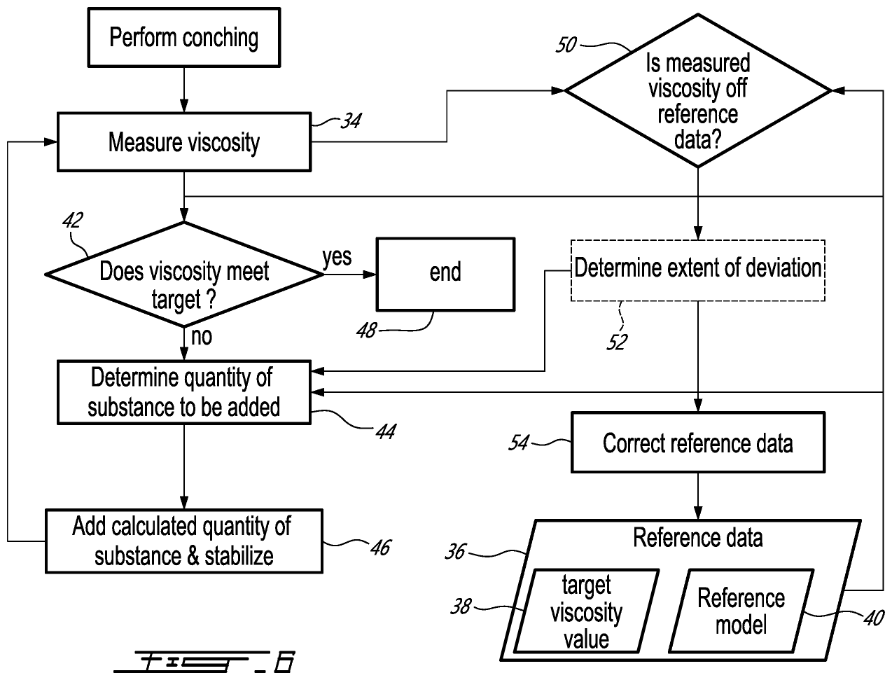

The flow chart presented in FIG. 6 presents a more elaborated embodiment in which one or two additional features can be present. The first potential additional feature is to determine the extent to which the reference data deviates from the measurements 50, to calculate the potential error on this basis 52, and to adjust the quantity of added fat based on this error. For instance, the quantity of cocoa butter added can correspond to the quantity of cocoa butter indicated by the curve minus the expected error % based on the detected deviations. The second potential additional feature is that the reference data itself can be adjusted based on the detected deviation 54, and this can be performed either for subsequent cocoa butter additions to take place on the current batch, for reference use on subsequent batches, or both.

Indeed, with each and every measurement of a particular recipe more and more experimental points can be added the product's specific reference curve, and an exponential regression can be recalculated, taking all points into consideration, every time. When adding cocoa butter, the quantity of cocoa butter added can be adapted based on the correlation coefficient between the measured viscosity value(s) and the recalculated exponential regression. The closer to 1 the coefficient is, the more aggressive the system can be in determining the quantity of cocoa butter (i.e. determine a quantity closer to the value of the reference curve), while avoiding overdosing. As the quantity of experimental points increase over time, the average correlation factor may improve.

For example, a coefficient of 0.97 means that the reference curve represents very closely the values of viscosity which were measured for corresponding values of fat content. In such a case the system can use the value indicated by the curve to determine the exact quantity of butter to add with very little risk of over shooting.

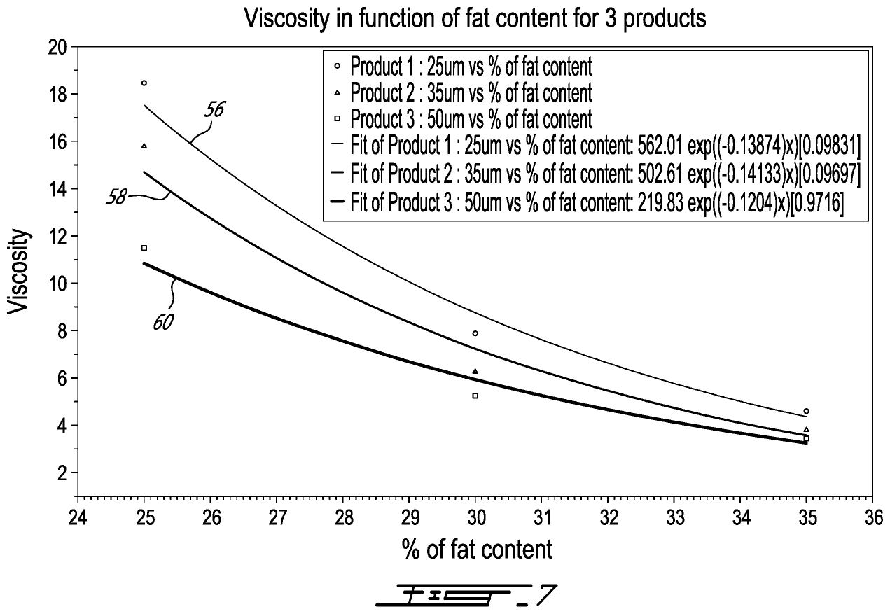

FIG. 7 shows three examples. Each example includes three measured viscosity values for a corresponding product/recipe. For each recipe, a curve fitting algorithm was used to determine the value of coefficients A and B which best fit the three experimental points, and the distance between the point and the corresponding curve is used to determine the coefficient. In the case of product 1, the coefficient of its curve 56 is 0.98, and in products 2 and 3, the coefficients of their curves 58, 60 are 0.97. In all these cases, the measured values are quite close to the fitted curves and the curve value of added cocoa butter may be used directly if the process otherwise allows it, as it will likely lead to a viscosity within the tolerances of the viscosity specifications.

In order to have a curve that adapts to changes in raw material, environmental conditions, and/or other progressive changes, a weight factor can be applied to the newer points. This weight factor can be selected to be 1/number of days since the last measurement, for instance, leading for example to a scenario where a point that was taken over a year ago will have 1/360 the weight of a point taken today. Such an approach would allow to ensure that fresh data gets priority over older data, while not completely neglecting the entire history. Depending on the software application used, all weight factors can be updated at midnight every day, for instance. Additional development of the algorithm, or use of machine learning, for instance could allow to factor in time-varying factors such as seasonal fluctuations, potentially allowing for an even more accurate prediction.

In order to be able to monitor viscosity change in time, each point distance to the curve can be recorded and plotted as a function of time. This can allow to have a time base per product variation curve that will show problems with the process or with raw materials.

In one example, the viscosity adjustment can be performed using the following steps:

1—The conching ends, leading to the viscosity check step.

2—Recirculation across the viscometer begins.

3—Viscosity is monitored until the reading stabilizes (When recirculation starts the system may need a few minutes to give an accurate reading).

4—A temperature compensated time average value is taken from the viscometer (The viscometer makes the temperature correction).

5—Actual fat dose is calculated based on the actual mixer and conche dosing and not the theoretical recipe. This gives the mass actual fat content.

6—If the actual dosed lecithin does not fit the optimal value system adjusts. If adjustment required, back to step 3.

7—This new (% fat,viscosity) point is placed on the product reference curve.

8—The theoretical required fat content is calculated off the reference curve. The target viscosity is the average between the nominal viscosity and the positive tolerance. This gives the quantity of butter to add to reach the limit of the spec and to put as little butter as possible to meet the specification.

Fat % difference=(Theoretical fat % require to reach target viscosity−Actual fat %)

9—This quantity is reduced as a function of the correlation coefficient to prevent over shooting.

Butter addition [kg]=Actual weight in the conch*(Fat % difference)*Correlation coefficient

10—Adjustment is done.

11—If viscosity is not in range, go back to step 3; if in range skip to 12.

12—Wait until the discharge temperature is reached.

13—Take a sample.

14—Start emptying.

In practice, the data associated to each recipe can additionally include reference data for the algorithm, and this additional reference data can include the following parameters:Nominal Viscosity in CPS; Pos tolerance in %:(Default value, perhaps 10%), Neg tolerance in %:(Default value, perhaps 10%), Optimal lecithin value:(Default value, perhaps 0.5%); Quantity of fat to remove from the conche:(Default value perhaps 5%) Initial reference curve:Recalculated Reference curve equation with added viscosity measurement point(s); Reference curve correlation coefficient; Table with the reference curve value to allow manual adjustment. Moreover, the following data can be recorded in association with each recipe for reference:(time, % fat, viscosity, particle size):To get the regression rule; (time, distance from the regression curve):To get an idea of the precision of the model; (time, final fat %):To know when we need to update the official recipe. The recipe base calculated data can be as follows:Parameter of the equation:visco=A*e\hat{ }(Bx+C)+D;—Correlation coefficient R\hat{ }2;—Target viscosity. The job base recorded data can be as follows: 25 (time,% fat,viscosity,particle size):to have an idea of how the viscosity fluctuated in the job. The job base calculated data can be as follows:Butter addition that has to be done.

As can be understood, the examples described above and illustrated are intended to be exemplary only. The scope is indicated by the appended claims.

What is claimed is:

1. A method of producing chocolate comprising:
mixing ingredients into a cocoa mass, conching the cocoa mass, and, subsequently to at least one phase of said conching, measuring viscosity of the conched cocoa mass,
contingent upon said measured viscosity value being higher than a target viscosity value, determining, based on the measured viscosity and reference data representing a reference model of viscosity vs. viscosity-reducing substance content for the chocolate to be produced, a quantity of viscosity-reducing substance to be added to the cocoa mass to reach the target viscosity value, and adding, to the conched cocoa mass, the quantity of viscosity-reducing substance to be added.

2. The method of claim 1, wherein said determining the quantity of viscosity-reducing substance includes determining a difference between the measured viscosity value and a target viscosity value, associating the difference to a basic quantity of viscosity-reducing substance to be added based on a reference model, the basic quantity having a margin of error extending to a maximum quantity and to a minimum quantity from the basic quantity, and selecting, for the quantity of viscosity-reducing substance to be added, a value different from the basic quantity, but within the margin of error.

3. The method of claim 2 wherein said selecting includes selecting, for the quantity of viscosity-reducing substance to be added, the minimum quantity.

4. The method of claim 2 wherein said selecting includes selecting, for the quantity of viscosity-reducing substance to be added, the maximum quantity.

5. The method of claim 2 wherein the margin of error is determined based on the difference between the measured viscosity value and the target viscosity value.

6. The method of claim 5 wherein the margin of error is proportional to the difference.

7. The method of claim 1 leading to the preparation of a first batch of chocolate, further comprising repeating said steps to prepare a second batch of chocolate, subsequently to the preparation of the first batch, further comprising adjusting the reference model of viscosity vs. viscosity-reducing substance content based on the measured viscosity value of the first batch.

8. The method of claim 1 leading to the preparation of a first batch of chocolate, further comprising repeating said steps in a second iteration to prepare a second batch of chocolate, wherein an initial quantity of fat forming part of the ingredients mixed into the cocoa mass in the second iteration is determined based on the measured viscosity value of the first iteration.

9. The method of claim 8 wherein the initial quantity of fat in the first iteration is based on the reference model, wherein the initial quantity of fat of the second iteration is based on the reference model, the reference model being adjusted between the first iteration and the second iteration based on a measured deviation between the measured viscosity value and the reference model during the first iteration.

10. The method of claim 1 further comprising performing a subsequent conching phase, subsequently to said adding the viscosity-reducing substance.

11. The method of claim 10 further comprising measuring the viscosity of the conched cocoa mass following the subsequent conching phase, and, contingent upon said subsequently measured viscosity value being higher than a target viscosity value after the subsequent conching phase, determining, based on the subsequently measured viscosity and the reference data, a further quantity of viscosity-reducing substance to be added to the cocoa mass to reach the target viscosity value, and adding, to the conched cocoa mass, a viscosity-reducing substance containing the further quantity of viscosity-reducing substance to be added.

12. The method of claim 1 further comprising subsequently to the addition of the viscosity-reducing substance, stabilizing of the cocoa mass, and measuring viscosity of the stabilized cocoa mass.

13. The method of claim 12 further comprising: contingent upon said measured viscosity of the stabilized cocoa mass being higher than the target viscosity value, calculating, based on the reference data, a further quantity of viscosity-reducing substance to be added, and adding the further quantity of viscosity-reducing substance.

14. The method of claim 1 further comprising determining a difference between the viscosity-reducing substance content and measured viscosity to a corresponding reference viscosity-reducing substance content and reference viscosity forming part of the reference data.

15. The method of claim 14 further comprising adjusting the quantity of viscosity-reducing substance to be added based on the difference.

16. The method of claim 14 further comprising adjusting the reference data based on the difference.

17. The method of claim 1 wherein the viscosity-reducing substance is a fat containing substance.

18. The method of claim 17 wherein the fat containing substance is cocoa butter.

19. The method of claim 1 wherein measuring the viscosity includes recirculating cocoa mass from and to the conche across a viscometer.

20. A method of adding a quantity of viscosity-reducing substance subsequently to a given conching phase, the method including measuring the viscosity of the chocolate mass after the given conching phase, determining a quantity of viscosity-reducing substance to be added, adding the determined quantity of viscosity-reducing substance, and performing a subsequent conching phase, wherein said determining the quantity of viscosity-reducing substance includes determining a difference between the measured viscosity and a target viscosity value, associating the difference to a basic quantity of viscosity-reducing substance to be added based on a reference model, the associated quantity having a margin of error, and selecting, for the quantity of viscosity-reducing substance to be added, a value different from the basic value, but within the margin of error.

21. A process of producing a plurality of batches of a given recipe of chocolate, wherein for each batch, an initial quantity of viscosity-reducing substance and/or a subsequently added quantity of viscosity-reducing substance is determined based on a reference model associated to the recipe, and wherein the reference model is modified or updated between an earlier batch and a later batch based on one or more viscosity measurements taken during the preparation of the earlier batch.
